(19) United States
(12) Patent Application Publication
(10) Pub. No.: US 2003/0156541 A1
(43) Pub. Date: Aug. 21, 2003

(54) Method and system for reserving resources on an MPLS path

(76) Inventor: Zheng Haihong, Coppell, TX (US)

Correspondence Address: MERCHANT & GOULD PC, P.O. BOX 2903, MINNEAPOLIS, MN, 55402-0903, US

(21) Appl. No.: 10/081,398

(22) Filed: Feb. 21, 2002

(51) Int. Cl. H04J 1/16; H04J 3/16

(52) U.S. Cl. 370/235; 370/468

(57) ABSTRACT

A method and system is provided for an enhancement to an MPLS network that enables at least a portion of reserved resources along an existing LSP to be changed in response to changed/new flow(s) of packets from an existing connection without having to tear the existing LSP down and create a new LSP for the newly reserved resources. In a homogenous network (each router along an LSP practices the invention), an Enhanced LSR (ELSR) employs an Enhanced Multi-Protocol Label Switching (EMPLS) stack to generate EMPLS labels for the forwarding of packets along a new LSP. Once the LSP is setup with the EMPLS labels, the RSVP protocol can be used to change resource reservations at each ELSR along the existing LSP for changed/new flow(s) from an existing connection without tearing down the existing LSP and creating a new LSP.

### FIELD OF THE INVENTION

The present invention relates to reserving resources on networks, and more particularly to employing Multi-Protocol Label Switching (MPLS) and Resource ReserVation Protocol (RSVP) to modify reserved resources for a Label Switching Path (LSP) on a network.

### BACKGROUND OF THE INVENTION

A number of networks, such as the Internet or a mobile network, use “packet” technology to assist in transmitting data between computing devices. Packets are smaller groupings of the data being transmitted that include additional information about the data. In addition to the data which is being transmitted, the packets will normally include important transmission information such as the sender's identity or Internet Packet Address (IP Address), the addressee or intended recipient's IP Address, the actual data (or data request), and so on.

Each packet transmitted from a user's computing device will typically travel through several network devices such as hubs, switches, and routers. If a user's computing device is part of a local area network, the packet will generally travel along a cable until it arrives at a hub to which the cable is connected. The hub or “repeater” as it is sometimes called, will retransmit the packet to another network device (such as a switch) until the packet reaches a router. The router examines the information transmitted with the packet and determines the best way for it to get to its destination.

Once the router has determined how the packet is to be sent, it selects another router at some other location and transmits the message to the router in the direction the packet is intended to travel. For example, if the message is going from New York to California, the router might send the packet to a router located in an intermediate city such as Chicago along a high speed communication channel. Once there, another router will determine a subsequent router to which the packet will be sent next. In this way, the packet is transmitted from router to router until the packet has nearly reached its destination.

When the packet is near to its destination, it is eventually passed to a local hub, which retransmits the message to its intended recipient computing device. The recipient computing device then reassembles the packet with other parts of the original message to create the complete set of transmitted data. Thus, a router functions in a network by connecting wide area networks and local area networks to allow traffic and communication of packet information to be transmitted to selected destinations.

Various protocols and frameworks may be utilized in a network to enhance router-to-router transmission of packets. For example, a network may include a framework that allows packets being transmitted from a source to destination to be transmitted as a flow of packets along a predetermined path of routers. General Packet Radio Service (GPRS) is one example of mobile networks.

MPLS (Multi-protocol Label Switching), is an Internet Engineering Task Force (IETF)-specified framework that enhances network utilization by facilitating “paths” to transmit flows of packets from a connection to a destination. MPLS is utilized mostly for Internet protocol (IP)-based backbone networks, and can be established across multiple Layer 2 transport protocols such as ATM, Frame Relay or Ethernet. Thus, since MPLS offers the ability to create end-to-end communication paths with specific performance characteristics across networks using many types of transport protocols, the need for overlay networks or Layer 2 control mechanisms is reduced.

In an MPLS network, incoming packets from a connection associated with a path are assigned a “label” by a “label switching router (LSR)” at the ingress point of the network. These labeled packets are forwarded along a “label switched path (LSP)” where each “label switching router (LSR)” makes forwarding decisions based on the contents of the label. At each hop (LSR) along the LSP, an LSR strips off the existing label and applies a new label which tells the next hop (LSR) how to forward the packet towards the destination. When the packet reaches the last LSR at the end of the LSP, or egress point of the MPLS network, the label is “popped” or removed and the packet continues on towards its destination using a native packet forwarding protocol.

Label Switch Paths (LSPs) are established for a variety of purposes, such as to guarantee a certain level of performance for a flow of packets from a connection or to route a flow of packets around network congestion. The effect of LSPs are similar to circuit-switched paths/channels in Asynchronous Transfer Mode (ATM) or Frame Relay networks where channels are established across networks to transmit a “flow” or specific group of related packets.

Typically, the label is a short, fixed length, locally significant identifier which is used to identify a “forwarding equivalence class (FEC)” to which that packet is assigned. The FEC refers to a group of packets which are forwarded in the same manner (e.g., over the same path with the same forwarding treatment). By forwarding the packets along the LSP according to their label, the packets are also forwarded according to a specified FEC. When an LSR assigns a label to a forwarding equivalence class (FEC), the LSR lets its relevant peers know of this label and the label's meaning by distributing the label and the label's “binding” (i.e., relationship to a FEC) to other adjacent LSRs. The label values are of local significance, meaning that they pertain to the hops between LSRs. Since each label defines the bindings between two adjacent LSRs, the set of labels from the ingress LSR to the egress LSR in an MPLS network defines the Label Switched Path (LSP).

RSVP (Resource ReserVation Protocol) is a network-control protocol that may operate in conjunction with MPLS. The RSVP protocol is used in part to setup a new LSP and reserve resources at LSRs along the new LSP for a flow of packets from a connection to a destination. Resources are reserved for the forwarding of the flow of packets at each LSR according to a desired quality of service (QoS). In the past, RSVP was used to both set up a new LSP by distributing a set of labels between the LSRs along the LSP and also reserve resources at each LSR for the forwarding of the flow of packets along the LSP.

The IETF publishes several Request For Comment (RFC) documents that describe the operation of MPLS, RSVP and RSVP-TE over a network. For a description of the operation of MPLS, the IETF's RFC 3031 document, dated January of 2001, is hereby incorporated by reference. Also, for a description of the operation of RSVP, the IETF's RFC 2205 document, dated September of 1997, and RFC 2209 document, dated September of 1997, are hereby incorporated by reference. Furthermore, for the operation of RSVP-TE, the IETF's RFC 3209 dated, December of 2001, is hereby incorporated by reference.

Previously, when a flow(s) of packets from an existing connection changed, the RSVP protocol would tear down an existing LSP, setup a new LSP and reserve new resources for the changed flow(s) along the new LSP. Also, since the existing LSP was typically torn down at the same time that the new LSP was established, unwarranted levels of resource reservation at each LSR along the new LSP could occur for short periods of time. Under certain circumstances, the new LSP might not setup properly/quickly because the previous LSP had not yet been completely torn down. Accordingly, it would be desirable to have RSVP perform resource reservation on an existing LSP and not set up a new LSP when changes in reserved resources are necessary to handle changes in a flow(s) from an existing connection. It is with respect to these considerations and others that the present invention has been made.

### SUMMARY OF THE INVENTION

The present invention is directed at addressing the above-mentioned shortcomings, disadvantages and problems, and will be understood by reading and studying the following specification.

According to one aspect of the invention, a method is provided for dynamically modifying reserved resources for an existing connection along a Label Switched Path (LSP) in an MPLS network. An Enhanced Multi-Protocol Label Switching (EMPLS) protocol is employed to associate an EMPLS label with an LSP and an aggregated RSVP protocol such that the LSP setup and reservation of resources are separated into two distinct procedures.

In accordance with another aspect of the invention, the RSVP request message for modifying the resource reservation includes the EMPLS label used to setup the LSP so that the modified resource reservation corresponds to the LSP.

In accordance with yet another aspect of the invention, the EMPLS label used to setup the LSP is included in the RSVP path message so that the modified resource reservation corresponds to the LSP.

In accordance with still another aspect of the invention, each enhanced Label Switched Router (ELSR) is configured to include an EMPLS module. The EMPLS module operates to provide the functionality for dynamically modifying the resource reservation along an existing LSP.

In accordance with another aspect of the invention, the EMPLS label included in the RSVP message contains a different value in an extra bit field in comparison to the EMPLS label inserted into packets. The different value in the extra bit field is used to differentiate between an RSVP message containing an EMPLS label and packets that contain the same EMPLS labels.

According to yet another aspect of the invention, a method is provided for reserving resources on an MPLS based path in a network. At least one flow of packets from a connection to a destination is identified. The identified flow of packets is associated with a required resource for forwarding each packet towards the destination over the network. A first type of message such as an RSVP message or a Label Distribution Protocol (LDP) message is employed to establish an LSP in the network for at least one flow from the connection towards the destination. The LSP is established from an ingress router to an egress router in the network. A second type of message, e.g., an RSVP RESV message, is employed to reserve the required resource at each router along the LSP for at least one flow of packets from the connection. When a new resource is required for at least one flow of packets from the connection, the RSVP RESV message can be employed to reserve the newly required resource at each router that employs an enhanced MPLS (EMPLS) protocol and is disposed along the existing LSP. However, a new path is established with the first type of message for that portion of the existing LSP that includes a router that employs an MPLS protocol.

In accordance with another aspect of the invention, a set of labels are provided and each label corresponds to a router that forwards it towards the next router along the LSP. The label includes an EXP field. For each label that is forwarded by each router that employs the EMPLS protocol, an EMPLS indicator is included in the EXP field.

In accordance with yet another aspect of the invention, the set of labels are used with the second type of RSVP message to ensure that the message is forwarded to each router along the LSP.

In accordance with still another aspect of the invention, when at least two flows of packets from the connection have the same forwarding equivalence class (FEC), an aggregated RSVP message can be employed to reserve resources along the LSP for each flow of packets with the same FEC.

In accordance with a further aspect of the invention, the first type of RSVP message is employed to set up the new path for that portion of the existing LSP that includes at least one router that employs the MPLS protocol. Also, a new LSP is established that includes the new path in combination with another portion of the previously existing LSP that includes each router that employs the EMPLS protocol and is disposed along the previously existing LSP.

In accordance with yet another aspect of the invention, the existing LSP is torn down when the connection is closed.

According to a further aspect of the invention, an exemplary system such as a router is provided for that implements substantially the same actions as the methods described above.

### BRIEF DESCRIPTION OF THE DRAWINGS

FIG. 1 illustrates an exemplary GPRS based mobile Internet network in which the invention may operate;

FIG. 2A illustrates a schematic diagram that shows an exemplary Enhanced Label Switching Router (ELSR) in which the invention may operate;

FIG. 2B shows an exemplary functional block diagram of an ELSR;

FIG. 3 shows a schematic diagram that illustrates an exemplary system overview for an LSP in a homogeneous MPLS network;

FIG. 4A shows a schematic diagram that illustrates an exemplary system overview for an LSP in a heterogeneous MPLS network;

FIG. 4B further illustrates the schematic diagram for an LSP in a heterogeneous MPLS network;

FIG. 5A is an exemplary data structure for an MPLS label;

FIG. 5B is an exemplary data structure for an EMPLS label;

FIG. 6 shows a general overview of an exemplary process for forwarding flows of packets along an LSP in a homogeneous MPLS network;

FIG. 7A illustrates a general overview of an exemplary process for forwarding flows of packets along an LSP in a heterogeneous MPLS network; and

FIG. 7B further illustrates the general overview of the exemplary process for forwarding flows of packets along an LSP in a heterogeneous MPLS network, in accordance with the present invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. Each embodiment is described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings explicitly associated herein, unless the context clearly dictates otherwise. The term “packet” refers to an IP packet. The term “flow” means a flow of packets. The term “connection” refers to a flow or flows of packets that share a common path. The term “node” refers to a network element that interconnects one or more networks or devices. The term “user” refers to any person or customer such as a business or organization that employs a device to communicate or access resources over a network. The term “operator” refers to any technician or organization that maintains or services a packet-based network. The term “label” includes an MPLS label, a EMPLS label, or any other tag that conveys information regarding the data being transmitted.

The term “router” refers to a dedicated network element that receives packets and forwards them to their destination. In particular, a router is used to extend or segment networks by forwarding packets from one logical network to another. A router typically operates at layer 3 and below of the Open Systems Interconnection (OSI) reference model for networking. However, some routers can provide additional functionality that operates above layer 3 of the OSI reference model.

Generally, a router is aware of multiple paths that a received packet can take to its final destination. A router typically contains internal tables of information called routing tables that keep track of all known network addresses and possible paths throughout the internetwork, along with the cost of reaching each logical network. A router optimally routes packets based on the available paths and their costs, thus taking advantage of redundant paths that can exist in a mesh topology network. Some routers have static routing tables that must be manually configured with all network addresses and paths in the internetwork. Other routers are capable of automatically or dynamically creating their own routing tables by listening to network traffic. In an MPLS-based network, a router will forward a received packet along an optimal path towards its final destination based on the label included with the packet.

Referring to the drawings, like numbers indicate like parts throughout the views. Additionally, a reference to the singular includes a reference to the plural unless otherwise stated or is inconsistent with the disclosure herein.

A method and system is provided for an enhancement to an MPLS network that enables at least a portion of reserved resources along an existing LSP to be changed in response to changed/new flow(s) of packets from an existing connection without having to tear the existing LSP down and create a new LSP for the newly reserved resources. In a homogenous network (each router along an LSP practices the invention), an Enhanced LSR (ELSR) employs an Enhanced Multi-Protocol Label Switching (EMPLS) stack to generate EMPLS labels for the forwarding of packets along a new LSP. Once the LSP is setup with the EMPLS labels, the RSVP protocol can be used to change resource reservations at each ELSR along the existing LSP for changed/new flow(s) from an existing connection without tearing down the existing LSP and creating a new LSP.

In a heterogeneous network where both ELSRs and LSRs form the LSP, the RSVP or LDP protocol tears down that portion of the LSP associated with LSRs and sets up a new portion and reserve new resources for the changed/new flow(s) of packets from an existing connection. For the other portion that does include ELSRs, the RSVP protocol will not be used to tear that other portion down, but it will be employed to reserve resources at each ELSR along the other portion of the existing LSP for the changed/new flow(s) of packets from an existing connection. Also, the new portion will be coupled to the other portion to complete a “new” LSP that has newly reserved resources for changed/new flow(s) from an existing connection.

Therefore, the present invention can reduce the amount of processing required to set up LSPs in an MPLS network by separating the creation of a new LSP from the reservation of resources along an LSP. Also, since existing LSPs can be reused when resource reservations are changed for new/changed flows of packets from existing connections, modifications to existing resource reservations can occur more efficiently and faster along any portion of the existing LSP that employs ELSRs.

Additionally, the invention can operate with aggregated RSVP to reserve resources for a number of different packet flows that share the same desired QoS or FEC from the same connection. In the aggregated RSVP protocol, required resources for flows of packets are aggregated (added together) at the ingress router (aggregation router) and deaggregated at the egress router (deaggregation router), allowing a single resource reservation for multiple flows of packet from the same connection.

Illustrative Operating Environment

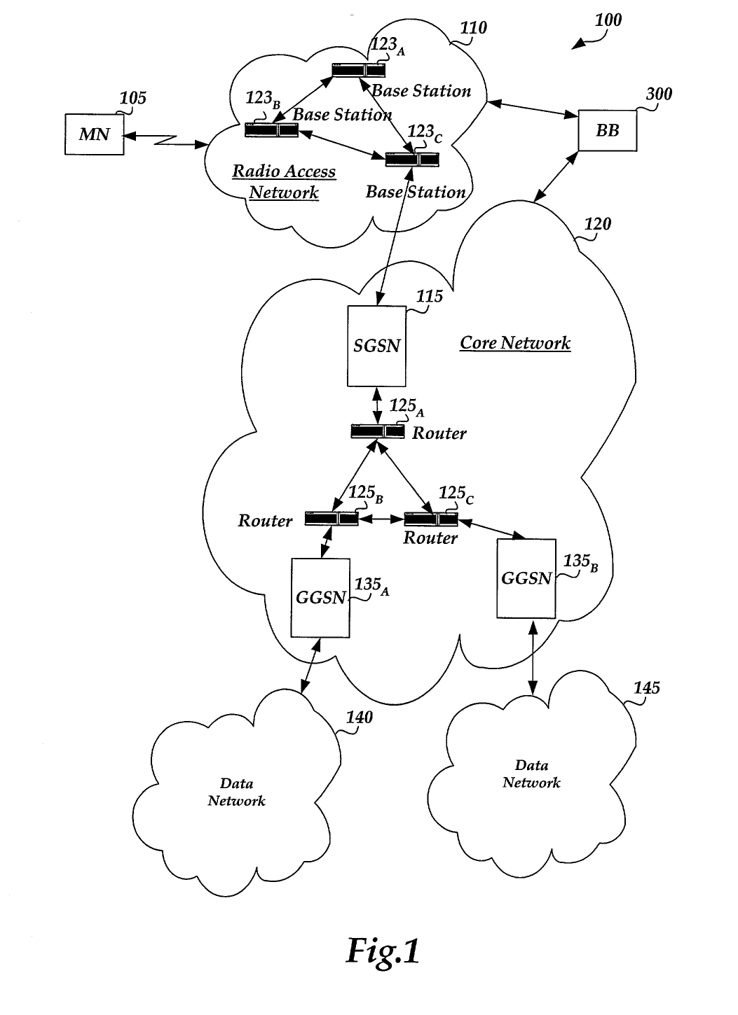

With reference to FIG. 1, an exemplary GPRS based mobile Internet network in which the invention may operate is illustrated. As shown in the figure, GPRS based mobile Internet network 100 includes mobile node (MN) 105, radio access network (RAN) 110, SGSN 115, core network 120, base stations 123_{A-C}, routers 125_{A-C}, GGSNs 135_{A-B}, data network 140, and data network 145.

The connections and operation for GPRS based mobile Internet network 100 will now be described. Mobile node 105 is coupled to radio access network (RAN) 110. Generally, mobile node 105 may include any device capable of connecting to a wireless network such as radio access network 110. Such devices include cellular telephones, smart phones, pagers, radio frequency (RF) devices, infrared (IR) devices, integrated devices combining one or more of the preceding devices, and the like. Mobile node 105 may also include other devices that have a wireless interface such as Personal Digital Assistants (PDAs), handheld computers, personal computers, multiprocessor systems, microprocessor-based or programmable consumer electronics, network PCs, wearable computers, and the like.

Radio Access Network (RAN) 110 manages the radio resources and provides the user with a mechanism to access core network 120. Radio access network 110 transports information to and from devices capable of wireless communication, such as mobile node 105. Radio access network 110 may include both wireless and wired telecommunication components. For example, radio access network 110 may include a cellular tower and/or base stations that are linked to a wired telecommunication network. Typically, the cellular tower carries wireless communication to and from cell phones, pagers, and other wireless devices, and the wired telecommunication network carries communication to regular phones, long-distance communication links, and the like. As shown in the figure, RAN 110 includes base stations 123_{A-C}.

According to one embodiment of the invention, routers 125_{A-C} may calculate their own link loads as well as process link loads relating to other nodes on the network. The routers may send a warning message to other routers within the network when its link load exceeds a configurable threshold. When there is at least one link load within each available path from a source to a destination for a new flow that is above the configurable threshold, the new flow attempting to enter the network is rejected.

In yet another embodiment, one or more of base stations 123_{A-C} may have router functionality. Although not shown, Radio Network Controllers (RNCs) may also include router functionality.

Some nodes may be General Packet Radio Service (GPRS) nodes. For example, Serving GPRS Support Node (SGSN) 115 may send and receive data from mobile stations, such as mobile node 105, over RAN 110. SGSN 115 also maintains location information relating to MS 105. SGSN 115 communicates between mobile node 105 and Gateway GPRS Support Node (GGSN)s 135_{A-B} through core network 120.

Core network 120 is an IP packet based backbone network that includes routers, such as routers 125_{A-C}, to connect the support nodes in the network. The routers are intermediary devices on a communications network that expedite message delivery. On a single network linking many computers through a mesh of possible connections, a router receives transmitted messages and forwards them to their correct destinations over available routes. Routers may be a simple computing device or a complex computing device. For example, a router may be a computer including memory, processors, and network interface units. In the present invention, the routers in core network 120 support the MPLS protocol for routing a flow of packets from a connection towards a destination.

GGSNs 135_{A-B} are coupled to core network 120 through routers 125_{A-C} and act as wireless gateways to data networks, such as network 140 and network 145. Networks 140 and 145 may be the public Internet or a private data network. GGSNs 135_{A-B} allow mobile node 105 to access network 140 and network 145.

The operator may set threshold levels to determine whether or not to accept a new flow based on different service classes for a particular user or group of users. As mentioned above, the routers, or some other dedicated network element may be used for this purpose. For example, conversational traffic from user group A may be carried with an Expedited Forwarding (EF) class would have one threshold level, whereas conversational traffic from user group B carried with an Assured Forwarding (AF) class would have a different service level. A user of mobile node 105 may be differentiated into one of these user groups by the user Mobile Station Integrated Services Digital Network (MSISDN) number that is known to both the SGSN and the GGSN support nodes.

Furthermore, computers, and other related electronic devices may be connected to data networks 140 and 145. The public Internet itself may be formed from a vast number of such interconnected networks, computers, and routers. GPRS based mobile Internet network 100 may include many more components than those shown in FIG. 1. However, the components shown are sufficient to disclose an illustrative embodiment for practicing the present invention.

The media used to transmit information in the communication links as described above illustrate one type of computer-readable media, namely communication media. Generally, computer-readable media includes any media that can be accessed by a computing device. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media.

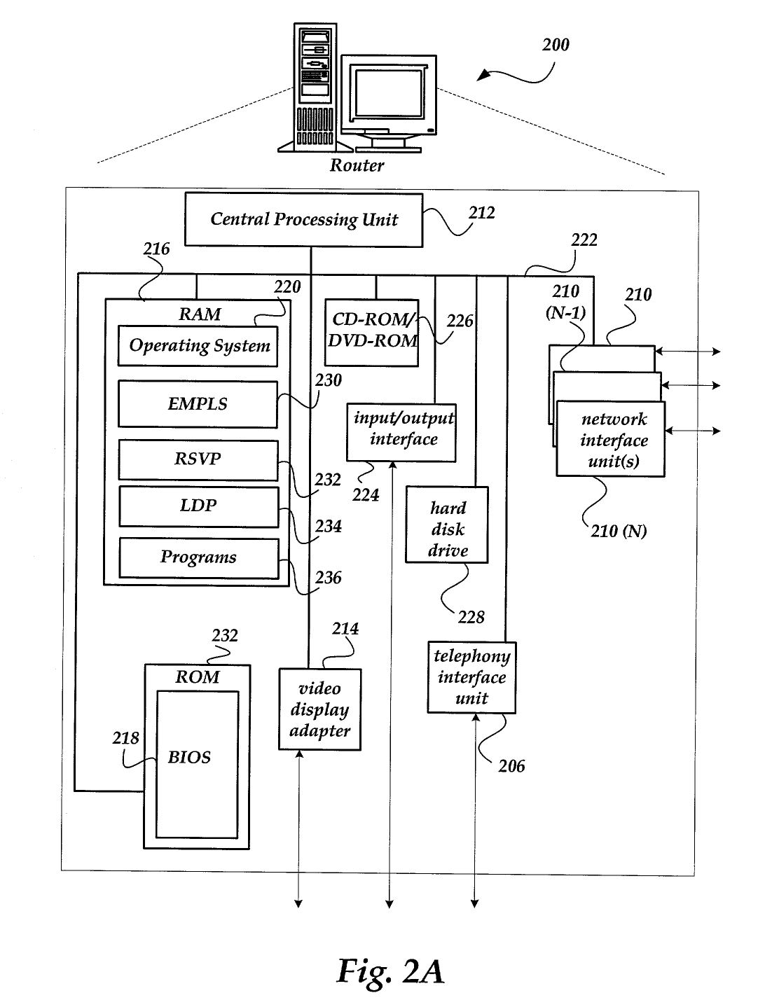

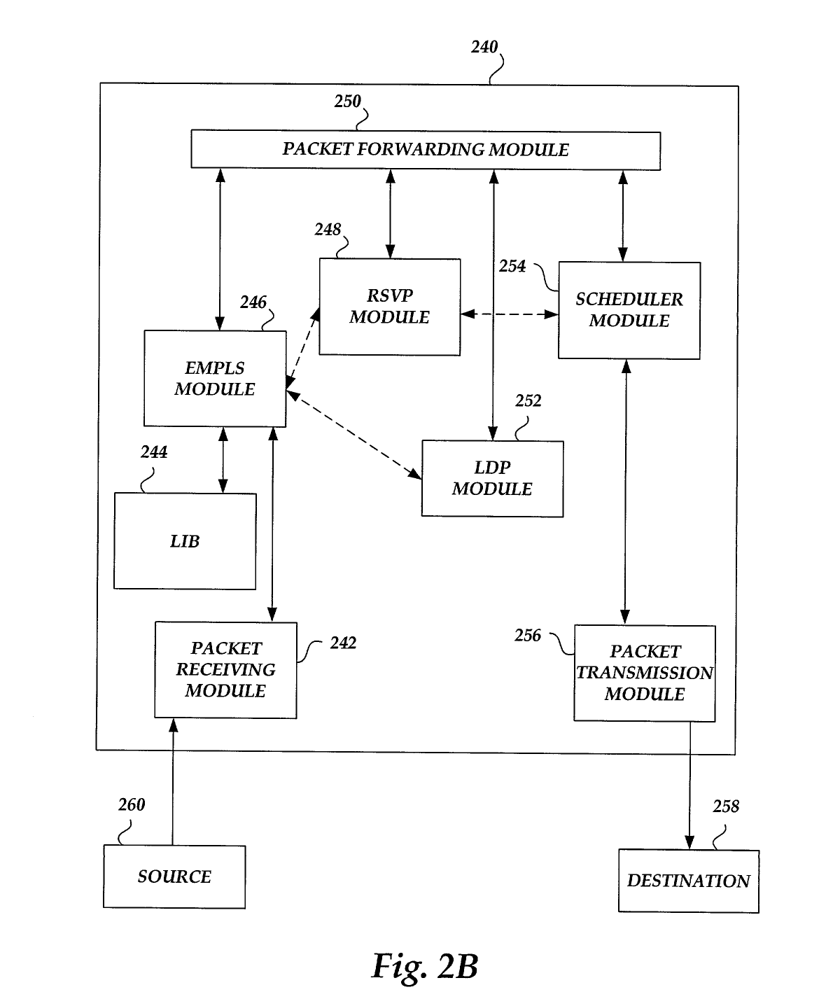

FIG. 2A is a schematic diagram that show an exemplary router 200 that is operative as an ELSR in an MPLS network. Router 200 may include many more components than those shown in FIG. 2. However, the components shown are sufficient to disclose an illustrative embodiment for practicing the present invention. As shown in FIG. 2, router 200 is connected to an MPLS network, or other IP based communications network, via network interface unit 210. Network interface unit(s) 210 includes the necessary circuitry for connecting router 200 to an MPLS network, and is constructed for use with various communication protocols including the COPS protocol that runs on top of TCP. Other communications protocols may be used, including, for example, UDP protocols. Often, network interface unit(s) 210 is implemented with an electronic card contained within router 200. Typically, there is one network interface unit 210 provided for each network connection to router 200.

Additionally, telephony interface unit 206 may be optionally provided to couple router 200 to core network 120. Telephony interface unit 206 may be configured to operate as a modem over an analog telephone line, e.g., a plain old telephone system (POTS) line. Alternatively, telephony interface unit 206 may be arranged to operate as a modem over a digital telephone line, e.g., a digital subscriber line (DSL) or an integrated services digital network (ISDN) telephone line.

Router 200 also includes processing unit 212, optional video display adapter 214, and a mass memory, all connected via bus 222. The mass memory generally includes RAM 216, ROM 232, and optionally, one or more permanent mass storage devices, such as hard disk drive 228, a tape drive, CD-ROM/DVD-ROM drive 226, and/or a floppy disk drive. The mass memory stores operating system 220 for controlling the operation of router 200. This component may comprise a general purpose operating system 220 as is known to those of ordinary skill in the art, such as UNIX, LINUX™, Microsoft WINDOWS NT®, and the like. Alternatively, the operating system may be specialized to support routing functions, such as the AmbOS® operating system provided by Nokia, Inc. Basic input/output system (“BIOS”) 218 is also provided for controlling the low-level operation of router 200.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data for an Enhanced Multi-Protocol Label Switching (EMPLS) stack 230, Resource reSerVation Protocol (RSVP) 232, and Label Distribution Protocol (LDP) application 234, and other programs 236 such as routing protocols, and the like. EMPLS 230, RSVP 232, and LDP 234 include computer executable instructions which, when executed by router 200, assist in reserving resources and forwarding a flow of packets from a connection towards a destination along an LSP. Also, the routing protocols may include Routing Information Protocol (RIP), Open Shortest Path First (OSPF), Border Gateway Protocol (BGP), Classless Inter-Domain Routing (CIDR), Simple Network Management Protocol (SNMP), and the like.

Router 200 may include a JAVA virtual machine, an HTTP handler application for receiving and handing HTTP requests, JAVA applets for transmission to a WWW browser executing on a client computer, an IPsec handler, a Transport Layer Security (TLS) handler and an HTTPS handler application for handling secure connections. Either the IPsec handler or the TLS handler may be used to provide security protection for the COPS protocol. HTTPS handler application may be used for communication with external security applications (not shown), to send and receive private information in a secure fashion.

Router 200 may also comprise an input/output interface 224 for communicating with external devices, such as a mouse, keyboard, scanner, or other input devices not shown in FIG. 2A. Likewise, router 200 may further comprise additional mass storage facilities such as CD-ROM/DVD-ROM drive 226 and hard disk drive 228. Hard disk drive 228 is utilized by router 200 to store, among other things, application programs, databases, and data used by EMPLS 230, RSVP 232 and LDP 234.

FIG. 2B shows an exemplary functional block overview of at least some of the modules and databases that are employed in the operation of Enhanced Label Switching Router (ELSR) 240 in an MPLS network. ELSR 240 is shown connected between source 260 (connection) and destination 258. Both source 260 and destination 258 may include another ELSR, LSR, node, gateway, or the like.

Each packet is received by packet receiving module 242, where each incoming packet is initially stored in a vacant area in a buffer. Packet receiving module 242 forwards the incoming packet to EMPLS module 246. EMPLS module 246 (labeler) examines the label of each incoming packet, or assigns a label to an unlabeled packet according to the entries included in label information base (LIB) 244. LIB 244 can include entries such as the relationship between labels, the connection from which the packet originated and a Forwarding Equivalence Class (FEC).

EMPLS module 246 replaces/adds the label to the packet with an appropriate outgoing label and forwards it to packet forwarding module 250. Packet forwarding module 250 provides general processing of the forwarding of each packet towards their destination and provides each packet to scheduler module 254. Scheduler module 254 forwards the outgoing labeled packet to packet transmission module 256 in accordance with the amount of resources that have been previously reserved for the forwarding of a flow of packets from the connection that the particular packet came from. Next, packet transmission module 256 transmits the outgoing labeled packet towards destination 258.

Packet forwarding module 250 operates with LDP module 252 to set up an LSP and operates with RSVP (Resource ReserVation Protocol) module 248 to reserve resources for the forwarding of a flow(s) of packets from a connection along an LSP. The actions associated with reserving resources for increases, decreases and modifications, to a flow(s) of packets from an existing connection along an existing LSP are described in greater detail above and below.

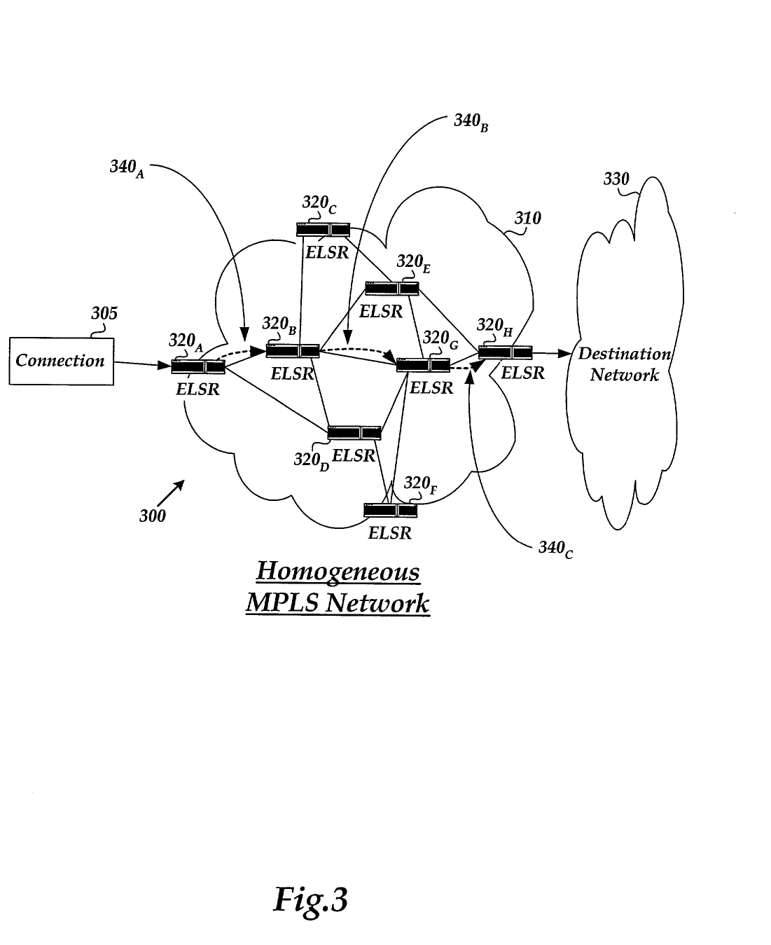

FIG. 3 shows an exemplary overview of a homogenous MPLS network 300 where each router is an ELSR as discussed in greater detail elsewhere in the specification. ELSRs 320_{A-H} are interconnected in a “mesh” of communication links. Also, ELSR 320_{A} operates as an ingress router coupled to connection 305 and ELSR 320_{H} operates as an egress router coupled to destination network 330. For a flow of packets from connection 305, an LSP is set up along paths 340_{A-C} , which extend between ELSRs 320_{A}, 320_{B}, 320_{G} and 320_{H}. In homogeneous MPLS network 310, the RSVP protocol is used to modify resource reservations along an existing LSP (paths 340_{A-C}) without tearing it down and creating a new LSP when the resource requirements change for a flow of packets from an existing connection, i.e., existing LSPs are reused with new resource reservations.

Communication links within MPLS network 310 may include twisted wire pair, fiber optics, coaxial cable, or may utilize analog telephone lines, full or fractional dedicated digital lines including T1 , T2, T3, and T4, Integrated Services Digital Networks (ISDNs), Digital Subscriber Lines (DSLs), wireless links, or other communications links. The number of connections, destinations, and routers in FIG. 3 may be increased or decreased without departing from the spirit or scope of this invention. As such, the Internet itself may be formed from a vast number of such interconnected networks, computers, and routers and that an embodiment of the invention could be practiced over the Internet without departing from the spirit and scope of the invention.

In FIG. 3, the LSP (paths 340_{A-C}) is initially set up for a flow(s) of packets that enter network 300 at ingress ELSR 320_{A} and exit the network at egress ELSR 320_{H}. At ingress ELSR 320_{A}, the flow(s) of packets from connection 305 are identified and the resources required to forward the flow(s) towards destination network 330 across MPLS network 310 are determined. A Label Distribution Protocol (LDP) such as RSVP can be used to initially set up the LSP between ingress ELSR 320_{A} and egress ELSR 320_{H}. Also, the RSVP protocol can be employed to reserve resources at each ELSR along LSP 340_{A-C} for the flow(s) of packets from connection 305. At each ELSR, an EMPLS label is added to each packet in the flow(s) from connection 305 and forwarded along LSP (paths 340_{A-C}) by each ELSR in the path until each packet reaches egress ELSR 320_{H}. In one embodiment, each ELSR swaps their EMPLS label for another EMPLS label in the packet which had been previously added to the packet by the previous ELSR on the LSP. In still another embodiment, each ELSR adds their EMPLS label to the EMPLS label (s) previously included in the packet.

At egress router ELSR 320_{H}, the EMPLS label is “popped” from each packet and the flow(s) of packets are forwarded to destination network 330 using the native forwarding protocol of the destination network.

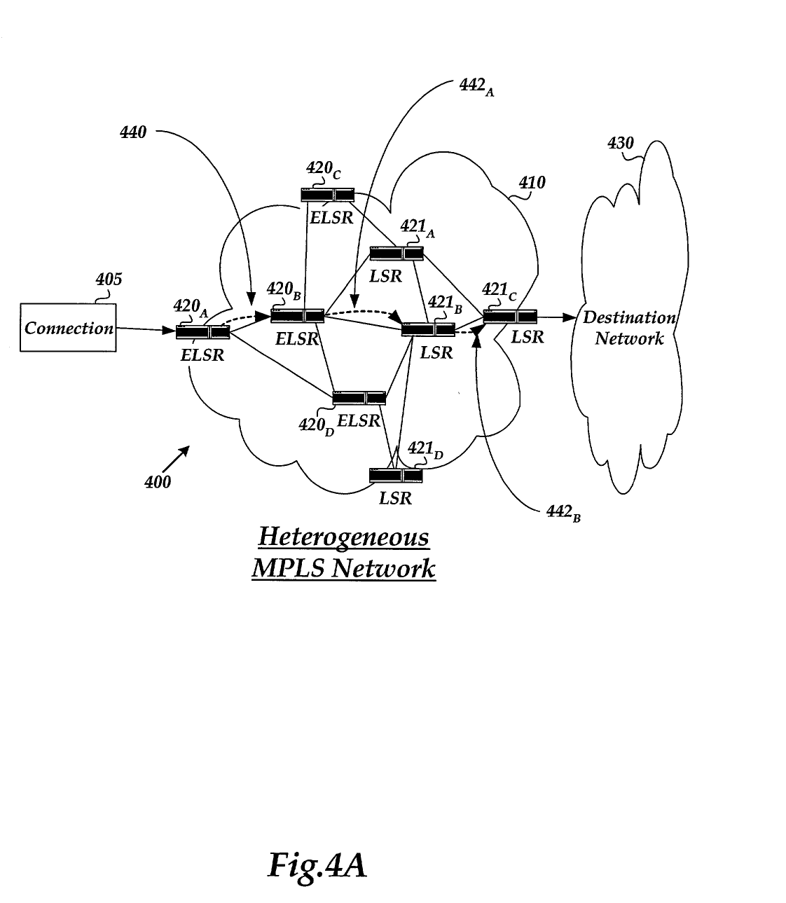

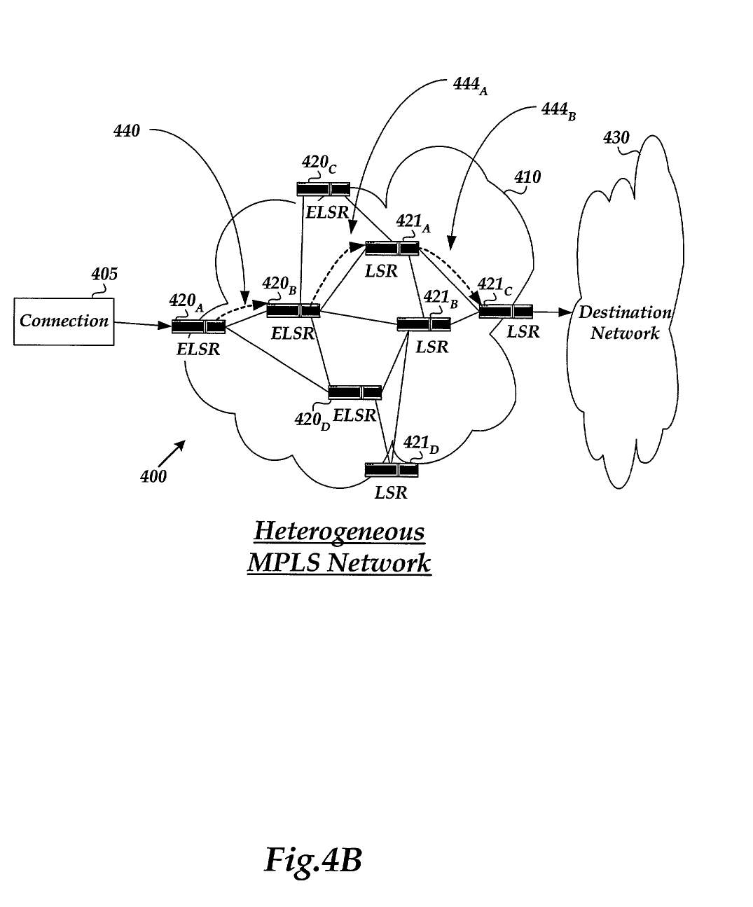

FIGS. 4A and 4B illustrate a heterogeneous MPLS network before and after the reserved resources have changed along an LSP for a flow of packets from a connection towards a destination. For FIGS. 4A and 4B, heterogeneous MPLS network 400 is coupled between connection 405 and destination network 430. Network 400 includes both Enhanced Label Switching Routers (ELSRs) 420_{A-D} and Label Switching Routers (LSRs) 421_{A-D}.

FIG. 4A illustrates an LSP that includes paths 440, 442_{A}, and 442_{B} The setup and reserved resources for the LSP are established in a manner substantially similar to those actions discussed above and below for paths between ELSRs and LSRs.

FIG. 4B illustrates another LSP that includes paths 440, 444_{A} and 444_{B}. The setup and reserved resources for the other LSP are established in a manner substantially similar to those actions discussed above and below for paths between ELSRs and LSRs. In that portion of heterogeneous network 400 that includes LSRs 421_{A-C} , paths 444_{A} and 444_{B} have been established to replace 442_{A} and 442_{B} which were torn down to change the reserved resources for at least one flow of packets from the connection.

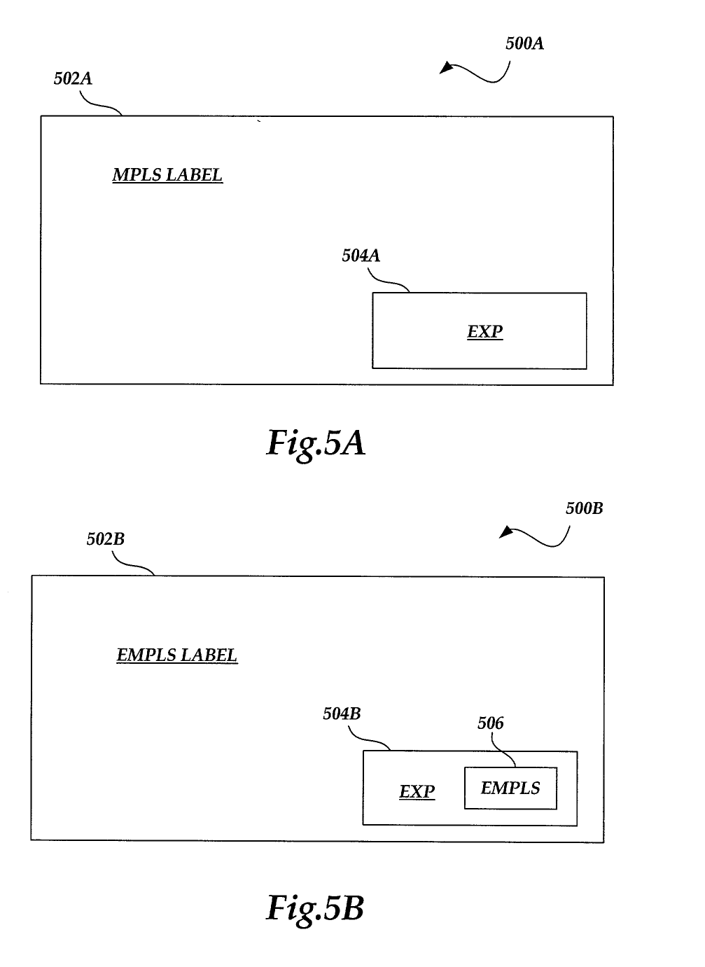

FIG. 5A illustrates an overview 500A of exemplary MPLS label 502A that includes an EXP field 504A and other information (not shown) regarding the forwarding of a labeled packet to the next router. Typically, an EXP field includes three bits. FIG. 5B shows an overview 500B of exemplary EMPLS label 502B, which is substantially similar to MPLS label 502A, except that EXP field 504B also includes an EMPLS field. According to one embodiment, MPLS/EMPLS labels are included in RSVP messages (either RSVP path message or RSVP RESV message) to reserve resources along an LSP. By including the same EMPLS/MPLS label, each subsequent RSVP message will follow the same path as an existing LSP.

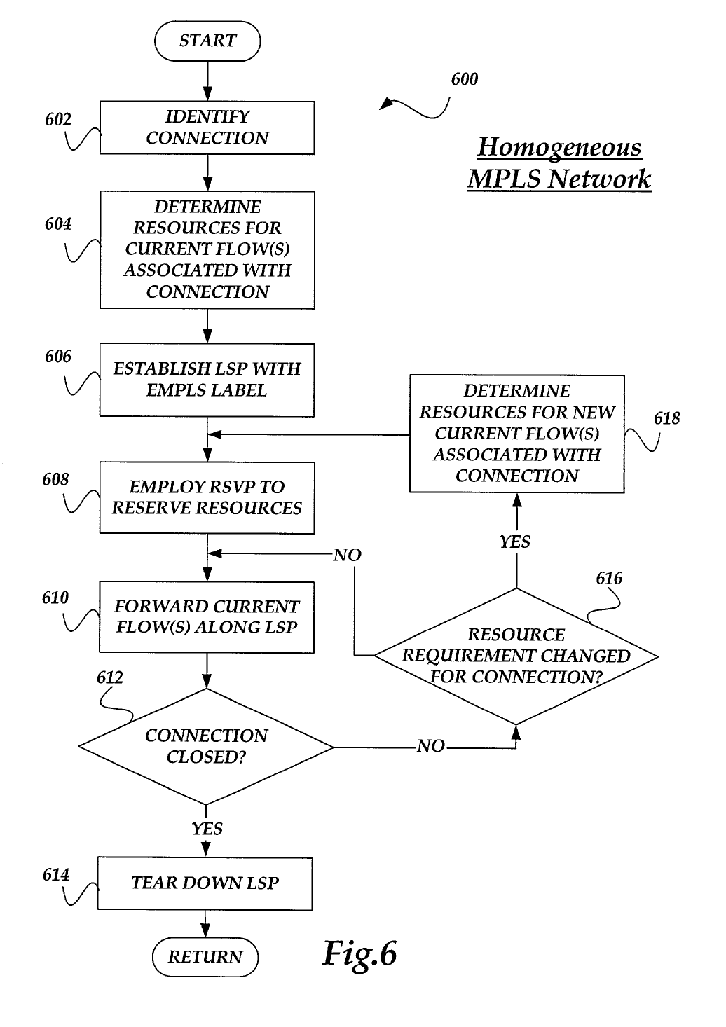

FIG. 6 illustrates a general overview of an exemplary process for forwarding a flow(s) of packets along an LSP in an MPLS network where each of the routers are ELSRs, i.e., they support Enhanced Multi-Protocol Label Switching as discussed above. Moving from a start block, where packets have entered the EMPLS network, the process advances to a block 602 where a connection for at least one flow of packets is identified by an ingress Enhanced Label Switching Router (ELSR). The ingress ELSR examines the incoming flow of packets and identifies those packets that share a common forwarding equivalence class (FEC) and/or are of the same flow. Upon identifying the connection, the process proceeds to block 604, where a determination is made for the amount of resources to be reserved along an LSP for the current flow or flows of packets associated with the connection.

Next, the process moves to block 606, where an RSVP path message or a LDP message is employed to establish an LSP between the ingress ELSR and an egress ELSR in the MPLS network. In another embodiment, an LDP protocol may be used to establish the LSP. An EMPLS label is assigned to each of the incoming packets of the flow(s) associated with the connection. As previously described with respect to FIG. 3, the EMPLS label includes additional information for implementing the functionality of the MPLS network.

The process continues at block 608, where a separate RSVP RESV message is employed to reserve resources along the LSP for the flow of packets associated with the connection. In one embodiment, the resource reservation may be established by using aggregated RSVP for multiple flows of packets that share the same FEC. In another embodiment, the resource reservation may be established by using standard RSVP for a single flow of packets that share the same FEC.

Next, the process moves to a block 610 where the current flow(s) of packets associated with the connection are forwarded along the LSP. The EMPLS labeled packets are forwarded at each ELSR along the LSP until the labeled packets reach the egress ELSR. At the egress ELSR, the EMPLS label is removed from the packets and they are forwarded towards their destination according to the native forwarding protocol in the destination network.

The process continues to a decision block 612 where a determination is made as to whether the connection is closed. The connection is closed when, after a period of time, the flow(s) of packets associated with the connection are no longer being received by the ingress ELSR. When the connection is closed, the process continues to block 614, where the LSP is torn down. Once the LSP is torn down and a connection is no longer present, the process returns to processing other actions.

Alternatively, when the connection is determined to still be open (forwarding a flow(s) of packets to the ingress ELSR), the process moves to a decision block 616, where a determination is made as to whether the resource requirement for at least one flow of packets from the connection have been increased, decreased or modified. If the resource requirement for the flow(s) of packets from the connection has not changed, the process returns to block 610 and continues processing other actions in substantially the same manner as discussed above. However, if the resource requirement has changed, the process advances to a block 618, where a new determination of required resources for the current flow(s) associated with the existing connection is made. For example, one flow of packets from the previously identified connection may include data related to a user's browsing activity at a web site, i.e., the downloading of HTML pages. However, when the user browses a web site that also provides streaming video, another flow of packets that requires more resources would be added to the previously identified connection.

Next, once the determination of required resources for the changed flow(s) of packets from the existing connection is made, the process returns to block 608, where an RSVP RESV message is employed to increase, decrease or change the resources along the existing LSP in accordance with the needs of the changed flow(s) of packets from the existing connection. The process continues to block 610 where other actions are processed in substantially the same manner as discussed above.

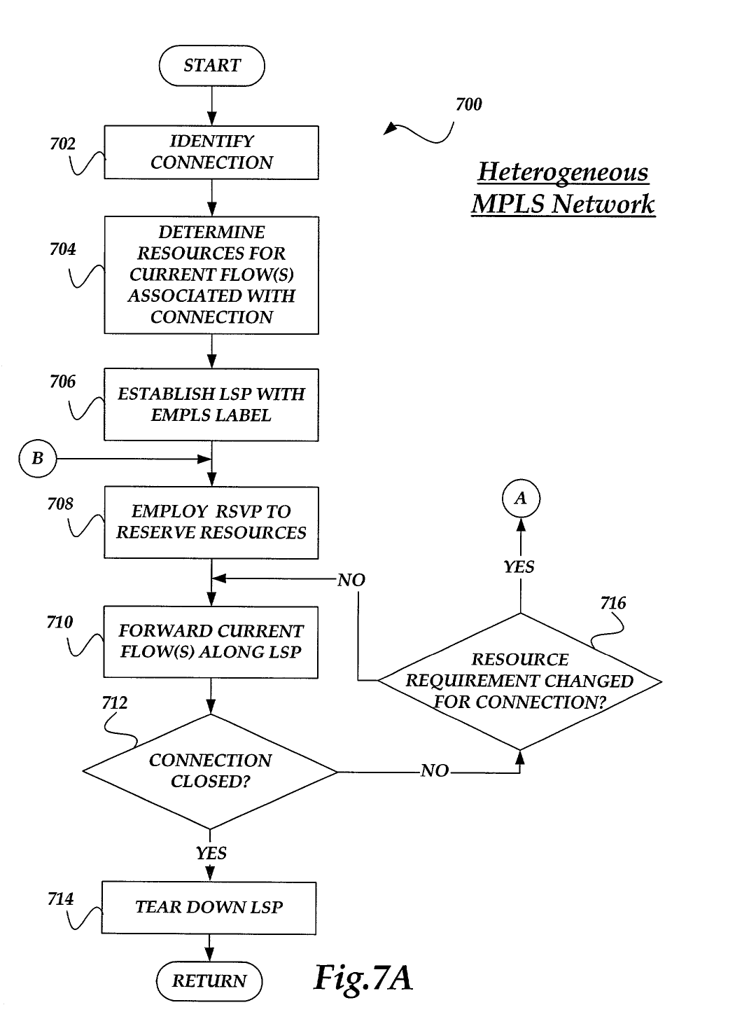

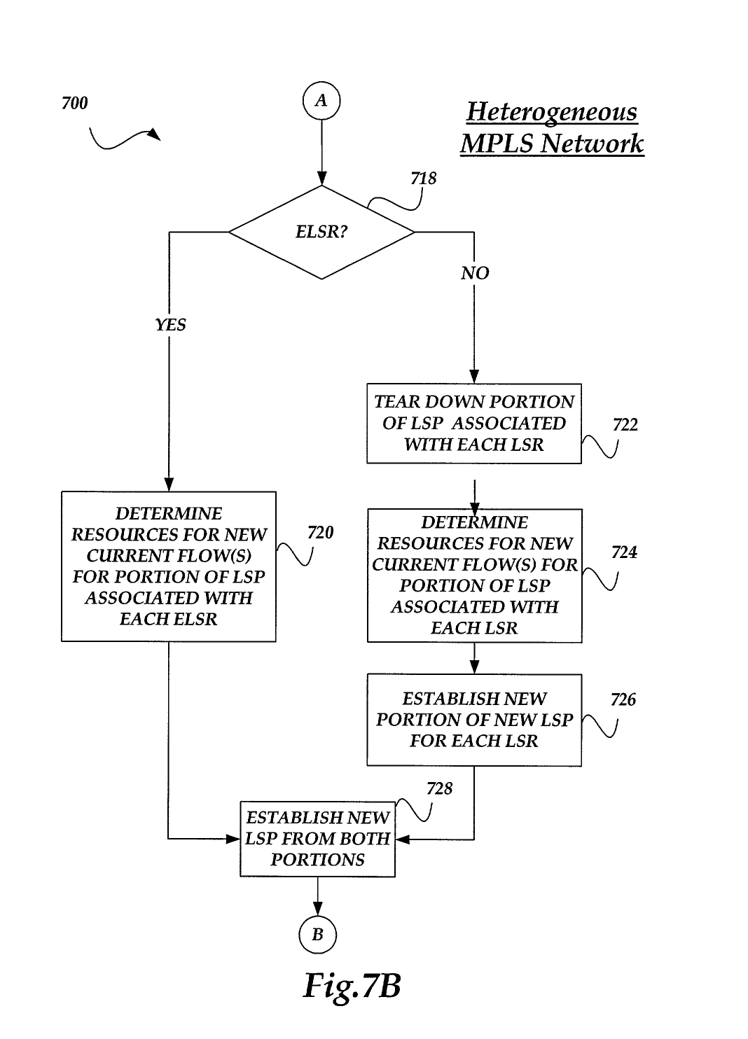

FIGS. 7A and 7B illustrate a general overview 700 of an exemplary process for forwarding a flow(s) of packets along an LSP in a heterogeneous MPLS network that includes both LSRs (label switching routers) and ELSRs (enhanced label switching routers). The processing of actions from block 702 through decision block 716 in FIG. 7A occurs in substantially the same way as the processing of actions discussed in regard to block 602 through decision block 616 in FIG. 6. The main differences being related to each router along the LSP may be an LSR, instead of an ELSR.

After performing the actions at block 702 through decision block 712 in substantially the same way as the actions performed at block 602 through decision block 612 in FIG. 6, the process moves to decision block 716 where a determination is made as to whether a change has occurred in the required resources for at least one flow of packets from the existing connection. If no change has occurred in the required resources for the flow(s) from the existing connection, the process returns to block 710 and continues processing actions in substantially the same manner as discussed above.

However, when the determination at decision block 716 is true (resource requirements have changed for the current flow(s) of packets from an existing connection, the process advances to decision block 718 as illustrated in FIG. 7B. For each router along the LSP, a determination is made as to whether it is an ELSR. If a router is an ELSR, the process advances to block 720 where the required resources are determined for the new current flow(s) of packets from the existing connection along that portion of the existing LSP that includes the ELSR. This process is repeated for each ELSR in the existing LSP and then the process flows to block 728.

Alternatively, when the determination at decision block 718 is negative (router is an LSR, not an ELSR), the process advances to block 722 where that portion of the existing LSP associated with each LSR is torn down. The process advances to block 724 where the new required resources are determined for the current flow(s) of packets from the existing connection. Moving to block 726, the process establishes a new portion for a new LSP along a path that includes LSRs. The process moves to block 728 where each ELSR portion of the existing LSP and each new LSR portion are combined to establish a new LSP that extends from the ingress router to the egress router. Next, the process returns to block 708 and employs the RSVP protocol to reserve resources at each ELSR and LSR along the new LSP. Stepping to block 710, the process returns to processing other actions in substantially the same manner as discussed above.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for reserving resources for at least one flow of packets on an MPLS based path in a network:
(a) identifying at least one flow of packets from a connection to a destination, wherein at least one flow of packets is associated with a required resource for forwarding each packet in at least one flow towards the destination over the network;
(b) employing a first type of message to establish an LSP in the network for at least one flow from the connection towards the destination; wherein the LSP is established from an ingress router to an egress router in the network;
(c) employing a second type of message to reserve the required resource at each router along the LSP for at least one flow of packets from the connection; and
(d) when a new resource is required for at least one flow of packets from the connection, employing the second type of message to reserve the newly required resource at each router that employs an enhanced MPLS (EMPLS) protocol and is disposed along the existing LSP, wherein a new path is established by the first type of message for that portion of the existing LSP that includes a router that employs an MPLS protocol, instead of a router that employs the EMPLS protocol.

2. The method of claim 1, further comprising a set of labels, wherein each label corresponds to a router that forwards it towards the next router along the LSP, wherein the label includes an EXP field, and wherein the EXP field includes an EMPLS indicator in each label that is forwarded by each router that employs the EMPLS protocol.

3. The method of claim 1, subparagraph (c), further comprises employing the same label with the second type of message as the first type of message to ensure that the message is forwarded to each router along the LSP.

4. The method of claim 1, sub-paragraph (a), further comprising determining that the packets in a flow have the same forwarding equivalence class (FEC).

5. The method of claim 1, sub-paragraph (c), further comprising when at least two flows of packets from the connection have the same forwarding equivalence class (FEC), employing an aggregated RSVP message to reserve resources along the LSP for each flow of packets with the same FEC.

6. The method of claim 1, sub-paragraph (d), further comprising:
(a) employing the first type of message to set up the new path for that portion of the existing LSP that includes at least one router that employs the MPLS protocol; and
(b) establishing a new LSP that includes the new path in combination with another portion of the previously existing LSP that includes each router that employs the EMPLS protocol and is disposed along the previously existing LSP.

7. The method of claim 1, further comprising tearing down the existing LSP when at least one flow of packets from the connection is stopped.

8. The method of claim 1, further comprising tearing down the existing LSP when the connection is closed.

9. The method of claim 1, subparagraph (b), wherein the first type of message is at least one of an RSVP message or an LDP message..

10. The method of claim 1, subparagraph (c), wherein the second type of message is an RSVP RESV message.

11. A method for dynamically modifying resources for a label switched path in a network:
(a) identifying a connection, wherein the connection includes one or more flows of packets that has an associated resource requirement;
(b) determining resources for the one or more flows of packets associated with the connection;
(c) establishing the label switched path, wherein a first label is associated with the label switched path and the packets of the one or more flows of packets associated with the connection;
(d) reserving resources along the label switched path for the one or more flows of packets associated with the connection by sending a first message that contains the first label along the label switched path that reserve the resources;
(e) forwarding the one or more flows of packets associated with the connection along the label switched path;
(f) determining whether a change of the resources requirement has occurred; and
(g) when a change of the resource requirement has occurred, modifying the resources reserved along the label switched path by sending a second message that contains the first label, wherein the second massage alters the resources reserved while avoiding establishing a new label switched path, whereby processing is minimized.

12. The method of claim 11, further comprising:
(a) determining whether the method operates within one of an enhanced Multi-Protocol Label Switching portion of the network and a non-enhanced Multi-Protocol Label Switching portion of the network, wherein the network is a heterogeneous network;
(b) when a change in resource requirement has occurred, tearing down the label switched path for the non-enhanced Multi-Protocol Label Switching portion of the network; and
(c) establishing a new label switched path for the non-enhanced Multi-Protocol Label Switching portion of the network.

13. The method of claim 11, wherein reserving resources further comprises ensuring the resource reservation is along the label switched path by configuring the second message with the first label such that the second message follows the label switched path.

14. The method of claim 11, wherein the second message includes a second label, the second label including a different value in an extra bit (EXP) field to differentiate the second label from the first label.

15. A router for forwarding packets to a final destination over an Multi-Protocol Label Switching (MPLS) network, comprising:
(a) a transceiver for receiving and transmitting each packet of one or more flows of packets from a source to a destination;
(b) a labeler for labeling each packet with a label according to a forwarding equivalence class (FEC) that corresponds to the label, wherein the forwarding equivalence class (FEC) is based on a kind of data included with each packet;
(c) a pathmaker for assisting in establishing a label switched path along which each packet is forwarded between an ingress router and an egress router of the enhanced Multi-Protocol Label Switching (MPLS) network, wherein the label switched path corresponds to the label of each packet;
(d) a reserver for assisting in reserving resources along the label switched path, wherein the reserver further assists in dynamically modifying resources reserved along the label switched path while avoiding establishing a new label switched path; and
(e) a scheduler that forwards each received packet along the label switched path towards the egress router, wherein the egress router removes the label and forwards each packet.

16. The router of claim 15, wherein the pathmaker and reserver operate independently from one another while maintaining a common association according to the label.

17. The router of claim 15, further comprising a label information base that stores a list of labels and a mapping of a relationship between each label and forwarding equivalence class (FEC).

18. The router of claim 15, wherein the labeler examines the label of the received packet to identify the kind of data included in the received packet.

19. The router of claim 15, wherein the reserver assists in using aggregated RSVP (Resource Reservation Protocol) to reserve resources along the label switched path for packets of different flows that correspond to the same FEC.

20. The router of claim 15, wherein the reserver assists in using RSVP (Resource Reservation Protocol) to reserve resources along the label switched path for packets of the same flow that correspond to the same FEC.

21. The router of claim 15, wherein the reserver assists in transmitting a message to reserve the resources along the label switched path, wherein the message includes the label.

22. The router of claim 15, wherein the label is a first label and the reserver assists in transmitting a message for reserving resource that includes a second label such that the message follows the label switched path but is discerned from packets containing the first label.

23. The router of claim 22, wherein the second label includes a different value in an extra bit (EXP) field to differentiate the second label from the first label.

24. The router of claim 15, wherein the transceiver, labeler, pathmaker, reserver, and scheduler are enabled to operate as an ingress enhanced label switching router (ELSR), an intermediate enhanced label switching router (ELSR), and an egress enhanced label switching router (ELSR).

25. A method for reserving resources for at least one flow of packets on an MPLS based path in a network:
(a) means for identifying at least one flow of packets from a connection to a destination, wherein at least one flow of packets is associated with a required resource for forwarding each packet in at least one flow towards the destination over the network;
(b) means for employing a first type of message to establish an LSP in the network for at least one flow from the connection towards the destination; wherein the LSP is established from an ingress router to an egress router in the network;
(c) means for employing a second type of message to reserve the required resource at each router along the LSP for at least one flow of packets from the connection; and
(d) when a new resource is required for at least one flow of packets from the connection, employing means for using the second type of message to reserve the newly required resource at each router that employs an enhanced MPLS (EMPLS) protocol and is disposed along the existing LSP, wherein a new path is established by the first type of message for that portion of the existing LSP that includes a router that employs an MPLS protocol, instead of a router that employs the EMPLS protocol.
